(19) United States
(12) Patent Application Publication
(10) Pub. No.: US 2026/0187046 A1
(43) Pub. Date: Jul. 2, 2026

(54) SYSTEM AND METHOD FOR UPDATING A VECTOR DATABASE THROUGH CONTINUOUS VECTORIZATION

(71) Applicant: Morphos AI, Inc., Chandler, AZ (US)

(72) Inventor: Gerald TOSCANO, Mesa, AZ (US)

(21) Appl. No.: 19/004,131

(22) Filed: Dec. 27, 2024

(51) Int. Cl. G06F 16/22; G06F 16/23

(52) U.S. Cl. CPC G06F 16/2237; G06F 16/2379

(57) ABSTRACT

A continuous vectorization system and method for updating a vector database is disclosed. The method includes receiving a new data and identifying within the vector database a target facet and a target facet vector, using at least one of a value of the new data and an attribute of the new data. The target facet vector belongs to the target facet. The method also includes generating an updated facet vector that reflects the new data by performing a weighted linear interpolation between the target facet vector and an update vector. The update vector is the new data in a vectorized form. The update vector is multiplied by a weight w produced by a weighting function and the target facet vector is multiplied by (1−w). The method includes storing the updated facet vector within the vector database.

### TECHNICAL FIELD

Aspects of this document relate generally to vector storage.

### BACKGROUND

Vector storage has emerged as a crucial element in the framework of modern

artificial intelligence (AI) and machine learning (ML) systems. Vectors, serving as numerical representations of data, encapsulate semantic meanings, thereby facilitating the efficient processing, retrieval, and comparison of extensive and complex datasets. The surge in demand for AI and ML applications which typically require vast quantities of data, underscores the need for efficient vector storage solutions. Nevertheless, traditional vector storage technologies encounter several challenges that can impede the performance, scalability, and cost-efficiency of AI systems.

Traditional vector storage struggles to efficiently manage continuous data streams. In AI applications handling substantial volumes of real-time data, such as social media platforms, recommendation engines, and financial analysis tools, the frequent updating of vector representations can impose a significant burden. Conventional approaches typically address this either by maintaining a single vector per data point or facet, or by storing each incoming piece of data as a distinct vector. Both approaches have significant drawbacks.

Utilizing the single vector approach necessitates re-vectorizing the entire dataset each time new data is received. This process entails recalculating all previous data for that data point to generate a new single vector representation, ensuring that the stored vectors remain concise and performant. However, the computational cost associated with this method is prohibitive. For example, in a social media application, a facet intended to represent the posts of a particular user, every new post would require re-vectorizing the entire history of posts and interactions, resulting in substantial computational overhead and inefficiency that will only increase over time. This approach is akin to rebuilding a house to change a lightbulb.

A more common approach is the method of storing each new data piece as an individual vector. This is attractive because it reduces the immediate computational costs by eliminating the need to reprocess existing data, and storage is inexpensive in comparison to compute. Nonetheless, this leads to an exponential increase in storage requirements. As data continually streams in, the database rapidly becomes bloated with vectors, many of which contain redundant or minimally varied information. This causes elevated storage costs and deteriorates search performance. For example, a recommendation system frequently updating user preferences would accumulate vast quantities of nearly identical vectors representing each minor change, thereby slowing searches and consuming excessive resources.

Traditional vector storage methodologies also grapple with maintaining data relevance and accuracy. When each data point is stored as an individual vector, searches can become imprecise due to noise from redundant vectors, complicating the retrieval of relevant information swiftly, especially in real-time processing and decision-making applications.

In addition to increased costs that can be a barrier to innovation and performance that degrades over time, the inefficiencies found in traditional vector storage also have environmental consequences. The computational power required to continuously update and store vectors results in high energy consumption, contributing to increased carbon emissions.

### SUMMARY

According to one aspect, a method for updating a vector database includes receiving a new data, and identifying within the vector database a target facet and a target facet vector, using at least one of a value of the new data and an attribute of the new data, the target facet vector belonging to the target facet. The method also includes generating an updated facet vector that reflects the new data by performing a weighted linear interpolation between the target facet vector and an update vector, the update vector being the new data in a vectorized form, with the update vector being multiplied by a weight w produced by a weighting function and the target facet vector being multiplied by (1−w). The method additionally includes storing the updated facet vector within the vector database.

Particular embodiments may comprise one or more of the following features. The method may further include generating the update vector by vectorizing the new data with an embedding model. The new data may be received as raw data. The target facet may include at most one vector. Storing the updated facet vector within the vector database may include overwriting the target facet vector with the updated facet vector. The method may further include storing the update vector within the vector database. The weighting function may depend, at least in part, on a vector count, the vector count being the number of vectors that have been combined through linear interpolation to yield the target facet vector. The weighting function may be average-based, and, if n is the vector count, the weight may be 1/(n+1). The weighting function may be order-based, and the weight may be equal to a decay factor that is greater than 0 and less than 1. The decay factor may be a function and may be dependent on an elapsed time since the target facet vector was last updated.

According to another aspect of the disclosure, a continuous vectorization system includes a vector database having a plurality of vectors and a plurality of facets, each facet describing at least one vector associated with the facet on the basis of at least one of a value and an attribute reflected by the vector. The system also includes a continuous vectorization server communicatively coupled to the vector database. The continuous vectorization server includes a processor and a memory, the memory having a weighting function and the processor configured to receive a new data and identify a target facet within the vector database using at least one of a value of the new data and an attribute of the new data. The processor is further configured to identify a target facet vector belonging to the target facet using the new data, retrieve the target facet vector from the vector database, and generate a weight w by applying the weighting function to at least a part of at least one of the target facet, the target facet vector, the new data in a raw data form, and the new data in a vectorized form. Additionally, the processor is configured to create an updated facet vector via a weighted linear interpolation between the target facet vector and an update vector by performing a linear interpolation between the update vector multiplied by the weight and the target facet vector multiplied by (1−w), and send the updated facet vector to the vector database for storage. The update vector is the new data in a vectorized form.

Particular embodiments may comprise one or more of the following features. The processor of the continuous vectorization server may be further configured to receive the new data from a client device communicatively coupled to the continuous vectorization server through a network. The vector database may be remote and may be communicatively coupled to the continuous vectorization server through a network. The new data may be raw data, and the processor of the continuous vectorization server may be further configured to generate the update vector by vectorizing the new data with an embedding model. The target facet may include, at most, one vector. Sending the updated facet vector to the vector database for storage may include instructing the vector database to overwrite the target facet vector with the updated facet vector. The processor may be further configured to send the update vector to the vector database for storage. The weighting function may depend, at least in part, on a vector count, the vector count being the number of vectors that have been combined through linear interpolation to yield the target facet vector. The weighting function may be average-based, and, if n is the vector count, the weight may be 1/(n+1). The weighting function may be order-based, and the weight may be equal to a decay factor that is greater than 0 and less than 1. The decay factor may be a function and may be dependent on an elapsed time since the target facet vector was last updated.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors'intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. §112(f). Thus, the use of the words “function,” “means” or “step” in the Detailed Description or Description of the Drawings or claims is not intended to somehow indicate a desire to invoke the special provisions of 35 U.S.C. §112(f), to define the invention. To the contrary, if the provisions of 35 U.S.C. §112(f) are sought to be invoked to define the inventions, the claims will specifically and expressly state the exact phrases “means for” or “step for”, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. §112(f). Moreover, even if the provisions of 35 U.S.C. §112(f) are invoked to define the claimed aspects, it is intended that these aspects not be limited only to the specific structure, material or acts that are described in the preferred embodiments, but in addition, include any and all structures, materials or acts that perform the claimed function as described in alternative embodiments or forms of the disclosure, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

The disclosure will hereinafter be described in conjunction with the appended drawings, where like designations denote like elements, and:

FIGS. 1A and 1B are schematic views of two embodiments of a continuous vectorization system;

FIGS. 2A and 2B are process views of the continuous vectorization systems of FIGS. 1A and 1B, respectively;

FIG. 3 is a process flow of a method for updating a vector database through continuous vectorization; and

FIG. 4 is a relevance plot of L2 distances from query vectors to result vectors obtained through standard and continuous vectorization.

### DETAILED DESCRIPTION

This disclosure, its aspects and implementations, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspect of the disclosed concepts to the embodiments illustrated.

Vector storage has emerged as a crucial element in the framework of modern artificial intelligence (AI) and machine learning (ML) systems. Vectors, serving as numerical representations of data, encapsulate semantic meanings, thereby facilitating the efficient processing, retrieval, and comparison of extensive and complex datasets. The surge in demand for AI and ML applications which typically require vast quantities of data, underscores the need for efficient vector storage solutions. Nevertheless, traditional vector storage technologies encounter several challenges that can impede the performance, scalability, and cost-efficiency of AI systems.

Traditional vector storage struggles to efficiently manage continuous data streams. In AI applications handling substantial volumes of real-time data, such as social media platforms, recommendation engines, and financial analysis tools, the frequent updating of vector representations can impose a significant burden. Conventional approaches typically address this either by maintaining a single vector per data point or facet, or by storing each incoming piece of data as a distinct vector. Both approaches have significant drawbacks.

Utilizing the single vector approach necessitates re-vectorizing the entire dataset each time new data is received. This process entails recalculating all previous data for that data point to generate a new single vector representation, ensuring that the stored vectors remain concise and performant. However, the computational cost associated with this method is prohibitive. For example, in a social media application, a facet intended to represent the posts of a particular user, every new post would require re-vectorizing the entire history of posts and interactions, resulting in substantial computational overhead and inefficiency that will only increase over time. This approach is akin to rebuilding a house to change a lightbulb.

A more common approach is the method of storing each new data piece as an individual vector. This is attractive because it reduces the immediate computational costs by eliminating the need to reprocess existing data, and storage is inexpensive in comparison to compute. Nonetheless, this leads to an exponential increase in storage requirements. As data continually streams in, the database rapidly becomes bloated with vectors, many of which contain redundant or minimally varied information. This causes elevated storage costs and deteriorates search performance. For example, a recommendation system frequently updating user preferences would accumulate vast quantities of nearly identical vectors representing each minor change, thereby slowing searches and consuming excessive resources.

Traditional vector storage methodologies also grapple with maintaining data relevance and accuracy. When each data point is stored as an individual vector, searches can become imprecise due to noise from redundant vectors, complicating the retrieval of relevant information swiftly, especially in real-time processing and decision-making applications.

In addition to increased costs that can be a barrier to innovation and performance that degrades over time, the inefficiencies found in traditional vector storage also have environmental consequences. The computational power required to continuously update and store vectors results in high energy consumption, contributing to increased carbon emissions.

Contemplated herein is a system and method for updating a vector database using continuous vectorization. The contemplated system and method addresses several critical challenges associated with traditional vector storage and computation. Similar to the conventional “single vector” approach, continuous vectorization (or CV) reduces a facet to one or a few vectors. However, rather than re-vectorizing an ever expanding set of data, the contemplated system and method adjusts the existing facet vector to reflect the influence the updated data would have by performing a weighted linear interpolation between the facet vector and the new or updated data in vectorized form. This linear interpolation maintains the semantic meaning of the facet vector without polluting the search space with noisy redundant vectors, according to various embodiments.

The contemplated continuous vectorization approach provides the computational benefits of the conventional “everything as a separate vector” method and the storage efficiency of the conventional “single vector” method. A facet, in the context of CV, has a single vector, or a few vectors, rather than the hundreds or thousands found in conventional systems. More beneficial than just a conventional “single vector”, these CV facet vectors can also be referred to as green vectors, reflecting the efficiencies and environmental benefits they provide through reduction in storage and energy use. This is in sharp contrast with the expensive inefficiencies of conventional vector storage approaches.

The use of weighted linear interpolation in the contemplated system and method eliminates the need for complete re-vectorization of datasets. By employing linear interpolation, continuous vectorization significantly reduces computational costs and storage bloat associated with handling high-dimensional data. In some applications, the contemplated CV approach reduced the storage requirements by as much as 90% when compared to conventional solutions, and those storage requirements remain at the same level over time, unlike those of conventional systems.

Advantageous over conventional methods, the continuous vectorization approach minimizes data redundancy and computational overhead by integrating new data into existing vectors rather than creating new (and often highly redundant) vectors for every minor change. This leads to a substantial reduction in energy consumption and carbon emissions due to the decreased computational power required.

The continuous vectorization technique also enhances data retrieval precision by reducing noise introduced by redundant vectors, facilitating quicker and more accurate information retrieval. Moreover, it addresses scalability issues as AI models grow in complexity and handle more diverse datasets, maintaining compact vector representations that scale efficiently without escalating storage and processing demands.

The contemplated CV system and method provides performant and accurate vector storage of high-dimensional data streams with lower computational and storage requirements than would be demanded by applying conventional methods to the same data stream.

The contemplated CV system and method introduces a novel approach to vector storage through the dynamic interaction between faceting and weighted interpolation, where facets serve as active semantic aggregation points that are continuously updated through a weighted interpolation process. This specific combination transforms how facets function in vector storage, moving beyond their traditional role as passive organizational units to become dynamic semantic maintainers that preserve meaning while dramatically reducing storage requirements.

Unlike conventional systems where facets merely organize static vectors, this approach enables facets to actively participate in maintaining semantic relationships through continuous weighted interpolation. This transformation is made possible through the specific interaction between faceting and weighted interpolation described herein, as neither component alone could achieve the dual benefits of semantic preservation and storage reduction.

It should be noted that while much of the following discussion is done in the context of a continuous vectorization system being applied in a social media-related use case where the vectors are being used for semantic search and comparison, the contemplated CV system and method may be applied to a wide range of additional vector storage use cases. The use cases discussed below are for illustrative purposes, and should not be taken as limitations to how the contemplated continuous vectorization system and method may be applied.

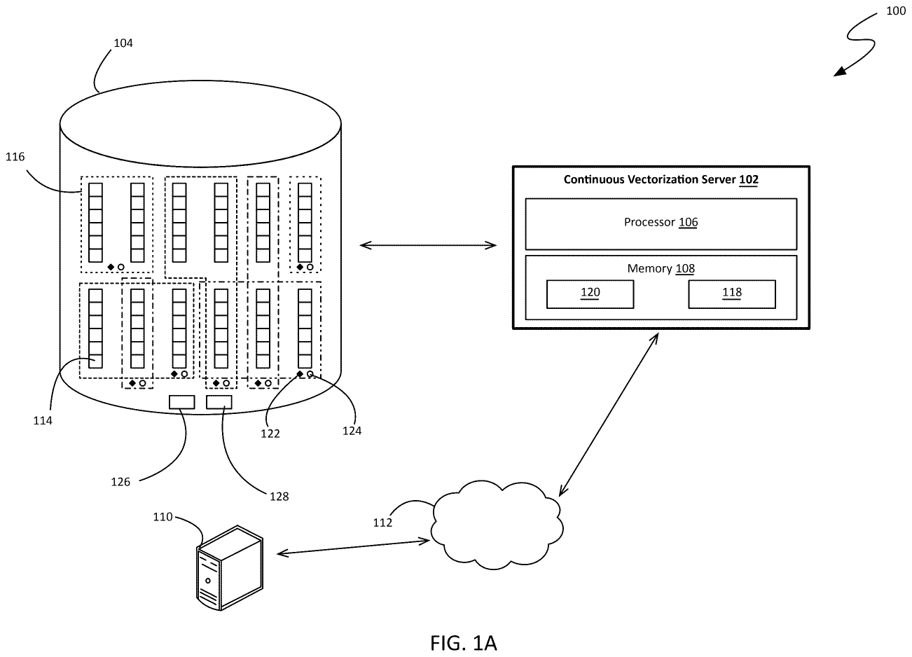

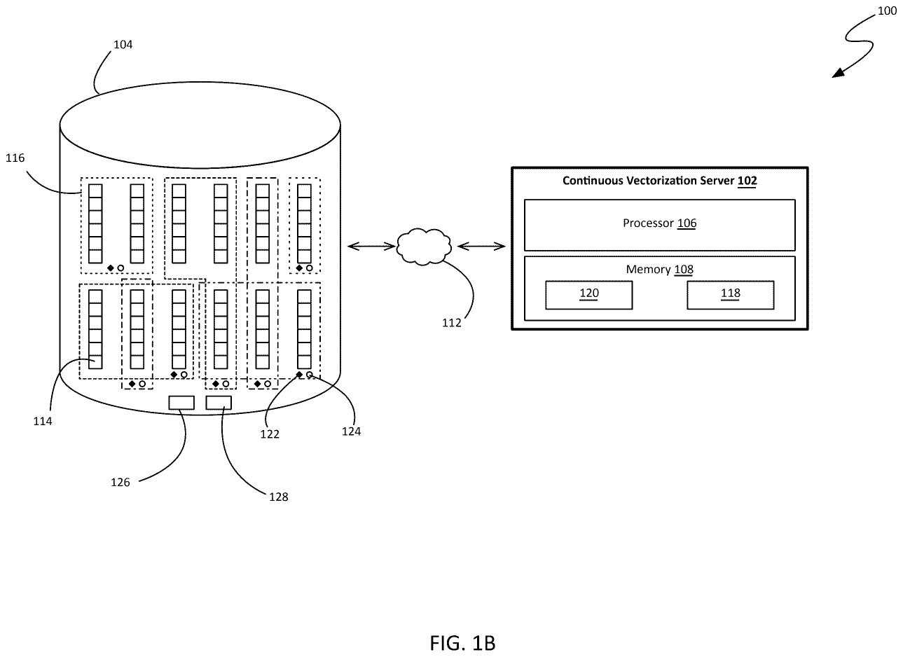

FIGS. 1A and 1B are schematic views of two non-limiting examples of a continuous vectorization system 100 for updating a vector database 104. Specifically, FIG. 1A shows a continuous vectorization system 100 providing “storage-as-a-service” through a network 112, with users interacting with the system 100 in a manner similar to that of a conventional vector storage service. FIG. 1B shows a continuous vectorization system 100 implemented as an in-house solution for a user, while coupled to a cloud-based vector database 104. These two embodiments, and others, will be discussed in greater detail below.

As shown, the continuous vectorization system 100 comprises a continuous vectorization server 102 that is communicatively coupled to a vector database 104. In some embodiments, including the non-limiting example shown in FIG. 1B, the continuous vectorization server 102 may be communicatively coupled to the vector database 104 through a network 112 (e.g., the Internet). Additionally, in some embodiments, the continuous vectorization server 102 may be communicatively coupled to one or more client devices 110 through the network 112.

In the non-limiting examples of a continuous vectorization system 100 shown in FIGS. 1A and 1B, the continuous vectorization server 102 is depicted as comprising a processor 106 and a memory 108, with the memory 108 holding various elements, such as a weighting function 120 and an embedding model 118. According to various embodiments, the continuous vectorization server 102 is a computing device comprising at least one processor 106 and able to perform the various functions that will be discussed below. The continuous vectorization server 102 may be implemented in a variety of hardware environments. In some embodiments it may be a discrete machine, while in other embodiments the continuous vectorization server 102 may be implemented in a distributed computing environment. In still other embodiments, the contemplated continuous vectorization server 102 may be implemented in a containerized environment, or as a virtual machine. Those skilled in the art will recognize that the continuous vectorization server 102 may be adapted to use a wide range of hardware environments. The depiction of the continuous vectorization server 102 as a single machine with a processor 106 in FIGS. 1A and 1B should not be interpreted as a limitation.

Additionally, the continuous vectorization server 102 comprises a memory 108, and that memory 108 comprises at least a weighting function 120. In the context of the present description and the claims that follow, for a server to comprise a memory 108 that comprises elements such as a weighting function 120 means that the weighting function 120 (or any other elements that are described as being in the memory 108) is maintained/stored in a fashion that makes it available to the processor 106 for use. This could be in long-term storage such as magnetic media or solid state storage, held in RAM, or otherwise accessible to the processor 106. The depiction of the weighting function 120 and an embedding model 118 being in the memory 108 of the continuous vectorization server 102 shown in FIGS. 1A and 1B should not be interpreted as a limitation. Those skilled in the art will recognize the various ways a routine such as the weighting function 120 or a model such as the embedding model 118 may be made readily available to the processor 106 for use.

The continuous vectorization system 100 comprises a vector database 104 that is communicatively coupled to the continuous vectorization server 102. In some embodiments, the vector database 104 may be a discrete computing device connected to the server, either locally or remotely through a network 112 (e.g., a cloud-based vector database 104, etc.). In other embodiments, the vector database 104 may be implemented in a distributed computing environment. In still other embodiments, the vector database 104 may be implemented within the same hardware environment as the continuous vectorization server 102 (e.g., same machine, same computing cluster, virtual machines or networked containers in the same hardware environment, etc.).

In some embodiments, the continuous vectorization server 102 may be communicatively coupled to one or more client devices 110, which may provide the continuous vectorization server 102 with new data streams, or request particular facets 116 and/or vectors 114 that have been stored in the vector database 104. In the context of the present description and the claims that follow, a client device 110 is any computing device able to interface with the continuous vectorization server 102 such that at least part of the server's functionality is made available. Examples range from a massive data center streaming large volumes of data to be stored in the vector database 104, down to a mobile device being used to perform a semantic search across a facet 116 using a web interface provided by the continuous vectorization server 102 over the network 112.

Those skilled in the art will recognize that the continuous vectorization server 102, the vector database 104, and the client device 110 may all be implemented in a wide variety of hardware environments. The specific environments depicted in the Figures and discussed herein are non-limiting examples.

According to various embodiments, the vector database 104 comprises a plurality of facets 116, each facet 116 describing (e.g., pointing to, identifying, etc.) at least one vector 114 that is associated with the facet 116. The vector database 104 may also comprise other elements such as a facet index 128 and/or vector index 126, as is known in the art. In some embodiments, the vector database 104 may be a conventional vector database 104, operating in a conventional way, unaware that it is being updated and maintained using the continuous vectorization methods contemplated herein. This means already existing vector storage can easily be adapted to employ the contemplated continuous vectorization method, and reap the associated benefits, without requiring substantial change. As a specific, non-limiting example, in one embodiment the continuous vectorization server 102 may utilize a cloud-based vector database 104 that is entirely unaware it is being updated in such a novel manner.

In other embodiments, the vector database 104 may differ from a conventional vector storage solution, having been modified to more deeply incorporate and implement continuous vectorization. For example, in some embodiments the continuous vectorization server 102 may be wrapped around a vector database 104 in such a way that the updating of facets 116 occurs in a seamless manner, such that the continuous vectorization server 102 acts as a conventional vector database from the point of view of a client device 110, but is actually the continuous vectorization server 102 blended with, and modifying, a vector database 104. As a specific, non-limiting example, in one embodiment, the continuous vectorization server 102 may present as a vector storage service that happens to provide a vector database that is fast and inexpensive because it is implementing continuous vectorization.

It should be noted that although much of the discussion of the vector database 104 will be done in the context of facets 116 and the vectors 114 that make them up, the vector database 104 does not have to be exclusively used for continuous vectorization. Any vectors 114 stored and updated via continuous vectorization will be interpolated, as will be discussed below. However, in some embodiments, those vectors 114 and facets 116 may be stored alongside non-CV vectors 114 and facets 116, in the same vector database 104. Continuous vectorization provides many benefits due to how it optimizes the updating of vectors. The initial storage and subsequent retrieval are not affected by the use of CV according to various embodiments; conventional vectors 114 and facets 116 may be mixed in with no ill effects.

The vector database 104 comprises a plurality of facets 116, each facet 116 describing at least one vector 114 associated with the facet 116. In the context of the present description and the claims that follow, a facet 116 is an organizational unit that encompasses multiple related vectors 114 based on some shared aspect. A facet 116 can serve as a category or filter for grouping vector 114. Facets 116 allow for more efficient processing and retrieval of a collection of vectors 114, as is known in the art.

The vectors 114 identified or pointed to by a facet 116 are grouped together based on a shared aspect of some form. Often, these vectors 114 are being grouped together based on their intended use or use context. However, the intended use or use context of a vector is not always immediately discernable, so a more expansive definition may be that the vectors 114 belonging to a facet 116 are associated with that facet 116 on the basis of at least one of a value 122 and an attribute 124 reflected by that vector 114.

In the context of the present description and the claims that follow, a value 122 reflected by a vector 114 is some part of the actual data represented by the vector 114. For example, in a case where a facet 116 is defined to include all social media posts and comments from a particular account, the vectors 114 belonging to that facet 116 are gathered based on the value 122 “username”.

Likewise, In the context of the present description and the claims that follow, an attribute 124 reflected by a vector 114 is a piece of information describing the vector 114 itself, or it's data before being vectorized by an embedding model 118. Examples include, but are not limited to, a data type (e.g., image, text, etc.), a content type (e.g., social media post, social media comment, etc.), metadata (e.g., identifier, timestamp, tag, source information, etc.), a size/length (e.g., number of characters, number of words, number of paragraphs, average sentence length, etc.), and the like.

Furthermore, In the context of the present description and the claims that follow, a value 122 or attribute 124 being “reflected” by a vector 114 means that the value 122 or attribute 124 of interest can be extracted from said vector 114. In some cases, it is part of the vector 114 as it exists within the vector database 104, like metadata. In other cases, it was part of the raw data that was vectorized and thus converted into the array of numbers that make up the vector 114. Those skilled in the art will recognize that there are other bases for grouping vectors into a facet 116.

There are a few differences between the facets 116 of a continuous vectorization system 100, and the facets 116 of a conventional vector storage solution. Conventional facets can be associated with hundreds, thousands, or even tens of thousands of vectors 114. The facets 116 of a continuous vectorization system 100 (meaning the facets 116 whose updates are handled using the methods contemplated herein), in contrast, will have a single vector 114, or perhaps a few vectors 114. This is not due to a limitation of continuous vectorization; the facets 116 of a continuous vectorization system 100 are capable of having just as many vectors 114 as the facets 116 of a conventional vector storage system. However, the CV facets 116 typically only require one or just a handful of vectors 114 to accomplish the facet's intended purpose. This will be illustrated below as part of a discussion of the computational, storage, and performance advantages provided by the contemplated continuous vectorization system 100 over conventional vector storage solutions.

How a facet 116 is defined and what criteria is used to identify associated vectors 114 is highly dependent on the specific use case. According to various embodiments, a facet 116 functions like a filter used to separate out a subset of vectors 114 from the larger set. The better defined the filtering criteria, the less extraneous information or “noise” will be gathered, leading to more accurate and timely results.

In some embodiments, the definition of a new facet 116 may begin with pre-filtering data to ensure that only relevant information is processed, thereby avoiding the inefficiencies associated with indiscriminate data inclusion. This pre-filtering process requires a clear understanding of the specific criteria or attributes that are significant to the intended searches, as these criteria form the basis for creating facets 116. Although facets 116 can be added later, it may require re-vectorization, which can be resource-intensive.

It should be noted that transitioning a conventional facet, where each data point is a separate vector 114, into a continuous vectorization facet 116, is simply a matter of performing a linear interpolation of those vectors 114, combining them into a single vector 114, for example. The computational cost to perform such a transition would be small, as linear interpolation can be an inexpensive operation, as are some (but not all) weighting functions.

According to various embodiments, the vectors 114 of a continuous vectorization system 100 are no different from the vectors 114 found in any conventional vector database 104. The vectors 114 contain data (i.e., the array of numerical elements that are output by an embedding model) that reflect a value 122 (i.e., the raw data that was fed into the embedding model). As is known in the art, the vectors 114 may also each comprise metadata, or attributes 124. Examples include, but are not limited to, identifier/index, timestamp, label, category, tags, description, user ID, source, data type, creation date, update date, update iteration, score, and the like.

An embedding model 118 is a machine learning model that transforms high-dimensional data into a lower-dimensional vector space, preserving the semantic relationships between data points. It is utilized to convert various types of data, such as text, images, or audio, into numerical representations that can be efficiently processed by algorithms for tasks such as clustering, classification, and similarity search. As is known in the art, this is particularly valuable in applications requiring natural language processing, recommendation systems, and image recognition, where it enhances the ability to analyze and interpret complex data by mapping it into a continuous vector space.

In some embodiments, new data (e.g., a data update, a data stream, etc.) is provided to the continuous vectorization system 100 in a vector 114 format. In other embodiments, new data may be provided to the continuous vectorization system 100 in its raw form. In the context of the present description and the claims that follow, raw data is data in a form that is readily usable by a human, such as text, images, video, or sound. When provided with raw data, the continuous vectorization server 102 will vectorize it using an embedding model 118 that is available to the continuous vectorization system 100 (e.g., stored locally and executable by the server 102, available on a cloud computing platform, accessible through an API, etc.). Just as the vectors 114 of a continuous vectorization system 100 are the same as the vectors 114 of a conventional system, the continuous vectorization system 100 contemplated herein is agnostic to what embedding model 118 is used to create those vectors 114, so long as they are in a format that the continuous vectorization server 102 and/or the vector database 104 is configured to handle.

It should be noted that while the term “continuous vectorization” is used to describe the system, method, and server contemplated herein, it is not meant to be taken literally. The term “continuous” isn't referring to a non-stop process of vectorization so much as it is referring to vectorization that does not backtrack. In a conventional system, data will be vectorized and re-vectorized with every update (or proliferate a large number of near identical vectors 114). In the contemplated system, the incoming data is vectorized once and then used to update the facet vector(s) through linear interpolation. The term “continuous vectorization” should be treated as a general description, and not as a strict limitation. As mentioned above, these vectors 114 that are updated through linear interpolation may also be referred to as green vectors, due to their resource efficiency and reduced environmental impact.

The contemplated system 100 may be implemented in a number of different ways, and may be presented to the end user in a number of different forms. FIG. 1A shows a continuous vectorization system 100 providing “storage-as-a-service” through a network 112, with users interacting with the system 100 in a manner similar to that of a conventional vector storage service. FIG. 1B shows a continuous vectorization system 100 implemented as an in-house solution for a user, while coupled to a cloud-based vector database 104.

In some embodiments, the continuous vectorization system 100 may be used to provide inexpensive and fast vector storage as a service. Users may be able to send new data 206 to the continuous vectorization server 102 as though it were a conventional vector storage service. However, as previously discussed, the definition of facets 116 is highly dependent on the specific use case. According to various embodiments, the continuous vectorization system 100 may provide an interface (e.g., web portal, app, API interface, etc.) to assist a user in defining the search conditions for a facet 116 that will then be updated using the methods contemplated herein. This may mostly appear to be a similar user experience as what is provided by conventional systems, except the continuous vectorization system 100 can provide the user a way to specify aspects of the weighting function 120 to be used in the interpolation, a feature that does not appear in conventional vector storage systems. However, in other embodiments, the continuous vectorization system 100 may appear indistinguishable from a conventional vector database 104 to an end user, with details such as type and parameters of the weighting function 120 being hidden from the end user.

According to various embodiments, the continuous vectorization server 102 is configured to receive new data 206 from a source, and then use that new data 206 to update the appropriate vectors 114 and facets 116 in the vector database 104. In some embodiments, including the non-limiting example shown in FIG. 1A, the source of the new data 206 may be a client device 110 communicatively coupled to the continuous vectorization server 102 through a network 112. In other embodiments, the source of the new data 206 may be local to the continuous vectorization server 102 (e.g., obtained from an internal network, pulled from a database local to the server 102, etc.). See, for example, the embodiment shown in FIG. 1B.

Additionally, in some embodiments, the new data 206 may be provided to the system 100 in vectorized form, as shown in FIG. 1A. In other embodiments, the system 100 may begin with new data 206 that is raw data 208 that the continuous vectorization server 102 must first vectorize with an embedding model 118 before using the new data 206 (in vectorized form) to update the vector database 104. In some embodiments, the new data 206 may be accompanied by a weight or information to be fed to the weighting function 120. In other embodiments, the weighting function 120 may operate automatically, having already been parameterized during the onboarding of the user.

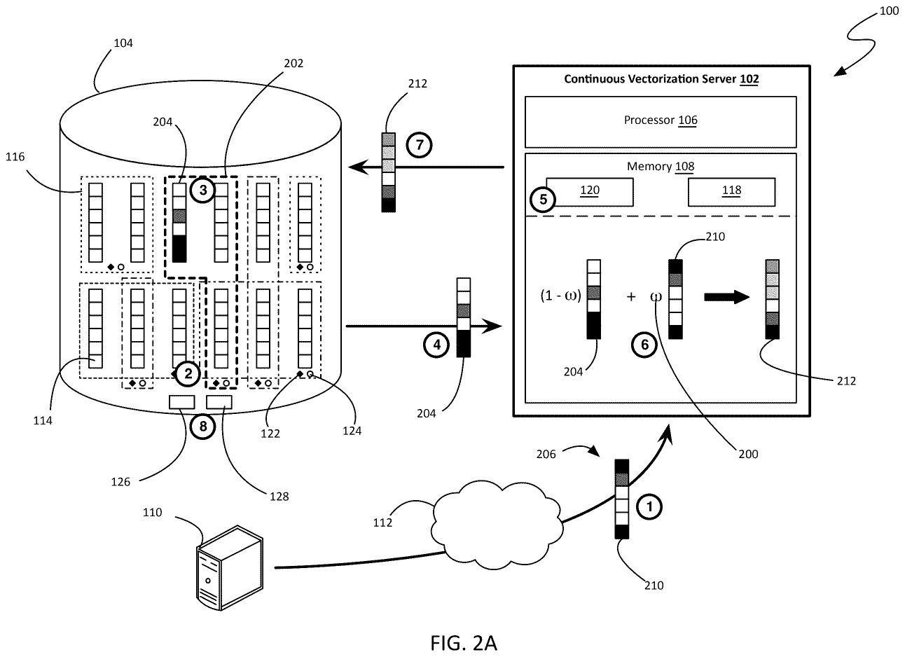

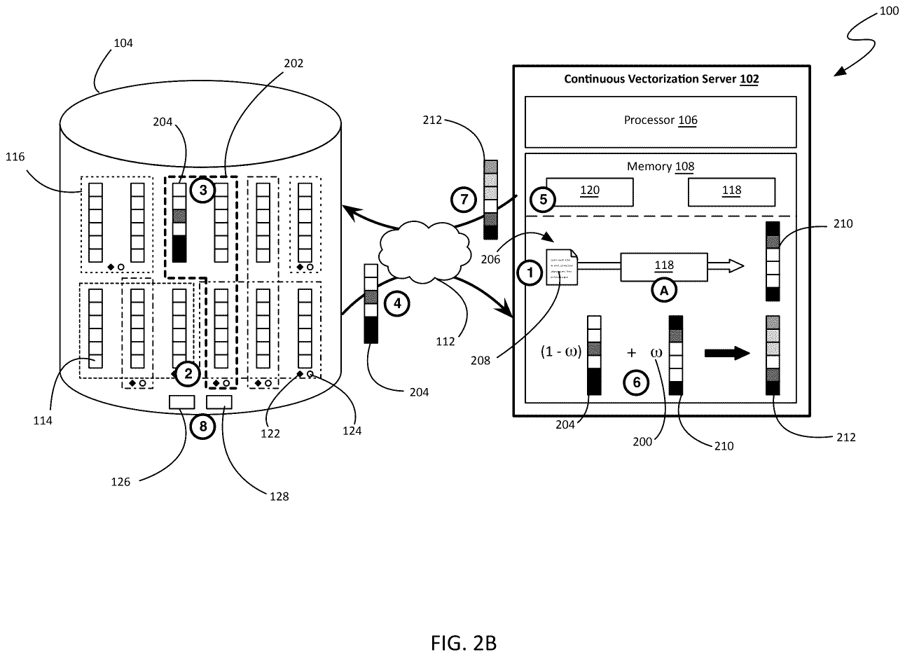

FIGS. 2A and 2B are process views of a non-limiting example of the application of the systems 100 of FIGS. 1A and 1B, respectively, to the updating of a vector database 104. First, the system 100 receives new data 206. See circle ‘1’ of FIGS. 2A and 2B. In some embodiments, the new data 206 may be received by the continuous vectorization server 102 in a vectorized form (i.e., as the update vector 210), as shown in FIG. 2A. In other embodiments, the continuous vectorization system 100 may be provided with new data 206 that is raw data 208 (e.g., text, images, sound, etc.) which will need to be vectorized. In some embodiments, the continuous vectorization server 102 is configured to generate the update vector 210 by vectorizing the new data 206 with an embedding model 118. See circle ‘A’ of FIG. 2B.

Next, the continuous vectorization server 102 identifies a target facet 202 within the vector database 104 that the new data 206 would be associated with. See circle ‘2’ of FIGS. 2A and 2B. According to various embodiments, the target facet 202 may be identified using a value 122 of the new data 206 and/or an attribute 124 (e.g., metadata, category, tag, etc.) of the new data 206.

Once the target facet 202 is identified, a target facet vector 204 belonging to the target facet 202 is identified using the new data 206 (e.g., using the value 122 and/or an attribute 124 of the new data 206, etc.). See circle ‘3’ of FIGS. 2A and 2B. It should be noted that while the following example will only include one facet 116 having one vector 114, in use there may be multiple facets 116 that would be affected by the new data 206, and some or all of them may have more than one vector 114 that should be updated with the new data 206.

After the target facet vector 204 is identified, it is retrieved from the vector database 104. See circle ‘4’ of FIGS. 2A and 2B. Before the update vector 210 (i.e., the vectorized form of the new data 206) and the target facet vector 204 can be interpolated, they need to be weighted. According to various embodiments, a weight 200 is generated by applying the weighting function 120 to at least a part of the target facet 202, the target facet vector 204, the new data 206 in a raw form (i.e., human-readable), and/or the update vector 210. See circle ‘5’ of FIGS. 2A and 2B. The weighting function 120 will be discussed in greater detail, below.

According to various embodiments, the weight 200 that is generated and the manner in which it is applied to the update vector 210 and the target facet vector 204 may be done to take into account any previous updates (i.e., weighted linear interpolations) that this target facet vector 204 has been through. In some embodiments, the weight 200 may be used as a “mixing coefficient” or “contribution factor” that describes how much influence the update vector 210 has on the resulting updated facet vector 212. With the weight 200 w less than 1 and greater than 0, these vectors may be weighted by multiplying the update vector 210 by w and multiplying the target facet vector 204 by one minus the weight 200 w. A linear interpolation is performed on the resulting weighted vectors to create an updated facet vector 212. See circle ‘6’ of FIGS. 2A and 2B.

The use of a linear interpolation to update the facet vectors is advantageous, because it maintains semantic meaning of the facet vector without polluting the search space with noise. The interpolation operation itself is significantly less computationally expensive as vectorization, providing a quick, computationally easy way to update a vector without the usual downside of increased storage usage.

Next, the result of the linear interpolation, the updated facet vector 212, is stored in the vector database 104. See circle ‘7’ of FIGS. 2A and 2B. In some embodiments, the target facet vector 204 may be overwritten by the updated facet vector 212, accomplishing an update without using up any additional storage space. In other embodiments, the target facet vector 204 may be replaced by the updated facet vector 212, but the previous facet vector may be retained to preserve a record of how the vector has evolved over time.

Finally, after the updated facet vector 212 has been stored, the vector database 104 may update the vector index 126 and/or the facet index 128 to reflect the update. See circle ‘8’ of FIGS. 2A and 2B.

In some embodiments, the update vector 210 may be discarded after the weighted interpolation has been performed. However, in other embodiments, the update vector 210 may also be stored in the vector database 104. This is what is done in conventional vector databases 104 that follow the “vectorize everything” approach.

Because continuous vectorization is so cheap, adding it on top of traditional vector storage may be beneficial if there is need for categorizing partitions of the data. Although such an arrangement would not provide any storage savings, the functionality of the database will be enhanced, with more precise and performant search.

The continuous vectorization system 100 and method contemplated improves upon the technology for updating a vector database in a number of tangible ways. This is better illustrated by examining a use case, and how the contemplated system 100 would perform against a conventional vector storage system.

As a specific, non-limiting example, consider the use case where vector storage is being used to capture and analyze the activities of a particular user of a social media site. A facet 116 is formed that is defined by the username, so that all posts made by that user will be represented by the vectors 114 of that facet 116. Over time, as that user makes posts on the site, their posts are sent to vector storage where they are associated with the facet 116 in anticipation of a subsequent use of the database (e.g., performing an engagement analysis for that user and a particular brand, a general sentiment analysis of their posts, a content trend analysis, etc.).

Using a conventional vector database for this exemplary use case could be accomplished with either of the two approaches previously discussed. The least burdensome approach, at least initially, would be to vectorize each new post as a separate vector 114 which is then stored in the vector database 104 and associated with the facet 116. Over time, as this user makes more and more posts, the number of vectors 114 in the facet 116 will balloon, slowing down searches and eating up storage space.

The other conventional approach is to combine all the posts of the user into one block of data, which is then vectorized into a single vector 114. In this scenario, the facet 116 only has one vector 114, resulting in quick searches and minimal storage use. However, the entire block of data will have to be re-vectorized with every new post from that user, and the computational costs will quickly become untenable.

In contrast, the continuous vectorization system 100 contemplated herein would take the best of both; the facet 116 would have a single vector 114 representing all of the user's posts. However, as new posts are made and their vectorized forms are sent to the system 100, they are combined with the existing vector 114 of the facet 116 through weighted linear interpolation. They are weighted such that every vector 114 that has been interpolated into the target facet vector 204 has an equal impact. The storage requirement does not increase, and the computational cost is barely more than what is required to vectorize a post. There is nothing preventing hundreds of additional vectors 114 from being associated with that facet 116, but it certainly is not necessary in the continuous vectorization solution.

Continuous vectorization overcomes the weaknesses of both conventional approaches discussed above, and is on par with their best attributes. According to various embodiments, continuous vectorization has low computational requirements because, assuming the new data 206 is provided in vector form, updating the facet 116 does not require any vectorization (or re-vectorization, in the case of a conventional system).

Additionally, continuous vectorization has low storage requirements because once an update vector 210 has been interpolated with the target facet vector 204 and the updated facet vector 212 has been stored in the place of the target facet vector 204, the update vector 210 is no longer needed, and is removed from memory unless there is some other use for it-continuous vectorization has no further need for it. Thus, the update does not increase the storage needed. According to various embodiments, the storage requirements for a continuous vectorization system 100 grow only with the number of facets 116 being updated, not the total amount of data coming in.

The conventional approach of vectorizing every new piece of data has another downside, apart from a rapidly expanding storage requirement. When every piece of data is vectorized and stored, the search space can quickly become noisy. All vectors appear the same no matter how important the data is or how off-topic it is, one vector will have the same importance as another in the search that is being performed. Additionally, in the use case where a facet is being updated with streaming data, the vectors formed from the streaming data may be very similar to each other.

Advantageously, continuous vectorization focuses on the facet 116. Using the facet 116 as a target allows the incoming data to be vetted before going much further in the update process. Through focusing only on relevant data, and by limiting the number of vectors 114 associated with the facet 116 to just one, or a few, the search space becomes clearer, yielding search results that are more accurate, but in less time than what would come from a conventional vector storage system.

Of course, there are exceptions. For example, re-vectorization may be needed in the continuous vectorization system 100 in cases where the intended end use has changed and the facets 116 are redefined or redirected. The storage savings provided by continuous vectorization may be lessened if iterations of the target facet vector 204 or the update vector 210 are preserved for versioning purposes. However, even with these exceptions, the continuous vectorization system 100 is still much more efficient and effective than conventional systems, according to various embodiments.

As mentioned above, vectors (i.e., the update vector 210 and the target facet vector 204) are weighted before they are blended through linear interpolation. According to various embodiments, the weights 200 used are produced by the continuous vectorization server 102 using a weighting function 120. According to various embodiments, the weighting function 120 depends on at least a part (e.g., a value 122, an attribute 124, etc.) of the target facet 202, the target facet vector 204. The weighting function 120 provides a degree of control over the behavior of the facet 116, allowing the facet's 116 operation to be fine-tuned to better accomplish its intended purpose.

There is a wide range of weighting functions that may be used in the contemplated continuous vectorization system 100. The following discussion will examine four examples, but it should be noted that other types of weighting function 120 exist, and the following discussion is for illustrative purposes, and not meant to limit the possibilities of what can be done.

In some embodiments, the weighting function 120 may be count-based, where the weighting function 120 will depend, at least in part, on a vector count of the target facet vector 204. In the context of the present description and the claims that follow, a vector count is the number of vectors 114 that have been combined through linear interpolation to yield the target facet vector 204. For example, a new vector 114 would have a vector count of 1. After the first update via interpolation, that vector count will be 2 (e.g., the original vector 114 and the update vector 210), and so forth.

According to various embodiments, the vector count may be used to create a weighting function 120 that considers the number of vectors 114 that have already been interpolated when determining what degree of influence a new update vector 210 will have on the target facet vector 204.

As a specific, non-limiting example, in one embodiment the weighting function 120 may be average-based, where the weight 200 is chosen to give all component vectors 114 of the target facet vector 204 the same level of influence. For example, when updating a target facet vector 204 that is the result of 998 interpolations, or 999 vectors total, the update vector 210 may be given the weight 200 of w =0.001, and the target facet vector 204 given the weight of (1−w)=0.999, such that in the resulting updated facet vector 212, each of the 1000 component vectors 114 has the same impact.

In some embodiments, the weighting function 120 may be order-based, where the weighting function 120 will make use of a decay factor a, which is less than 1 and greater than 0, according to various embodiments. Weighting the update vector 210 with a and the target facet vector 204 with (1−a) results in the impact of a vector 114 on the updated facet vector 212 decreasing as more and more vectors 114 are stacked in front of it. The value of a will determine how quickly that decrease happens. In other embodiments, the reverse may be implemented in similar fashion, where older vectors 114 increase in weight, and each new vector 114 has less impact than the previous vector 114.

In some embodiments, the weighting function 120 may be time-based, which is similar to the order-based function, except the decay factor is a function of the elapsed time since the target facet vector 204 was last updated, instead of a constant. This can be used to make the impact of a vector 114 drop off as time goes by.

In some embodiments, the weighting function 120 may be content-based, where the weighting function 120 will produce a weight 200 that takes into account at least one of a value 122 of the update vector 210 and an attribute 124 of the update vector 210, or new data 206 in a raw form (i.e. pre-vectorization form). Put differently, content-based weighting functions 120 are applied to value(s) and/or attribute(s) of the new data 206, either in its raw, human-readable form or in a vectorized form, to produce a weight 200, according to various embodiments. The application of this weighting function 120 is highly dependent on the specific use case being addressed. For example, in the case of analyzing the sentiment of the social media account of an individual, the weight 200 given to an update vector 210 that represents a new submission may be given a different weight depending on if it is an original post, or if it is responding to another user's original post. As another specific example, a content-based weighting function 120 could be used to make the weight 200 depend on the number of views, likes, or shares a post received in the first day, for a facet 116 defined to help determine the level of engagement with a particular product. As yet another specific example, a content-based weighting function 120 could be used to make the weight 200 depend on the number of people following the author of a reply, for a facet defined to help estimate the exposure a particular post may currently have.

In some embodiments, multiple weighting functions 120 may be used together as a “hybrid” weighting by applying different weighting functions to vectors belonging to the same facet 116. This may best be explained through a specific but non-limiting example.

According to cognitive science, the human mind tends to give “weight” on the basis of primacy and recency—people tend to assign both more memory and more credence to those things that happened first and those things that happened most recently, with the middle events having less emphasis. As a specific, non-limiting example, in one embodiment, a hybrid weighting based on the concepts of primacy and recency may be effected through the use of two vectors 114 within a facet 116, each the result of linear interpolations using different weighting functions 120. The first vector 114 would give greater weight to the newest data, and the second vector 114 would give greater weight to the oldest data. Any search within the CV database in this space would be more likely to hit the earliest or the latest data, with less emphasis given to what happened in between.

According to various embodiments, a hybrid weighting may be implemented through the use of multiple vectors within a facet, each implemented with a different weighting function 120. Each provides an opportunity for certain aspects of the data to “stand out” (e.g., the newest and oldest data in the example above).

It should be noted that these examples of weighting functions 120 is not exhaustive. One of the advantages of the contemplated system and method is different weights may be assigned for the linear interpolation on whatever basis desired. The use of a weighting function 120 allows the CV database to be designed to focus on just the important data (as defined by the user), resulting in significant advantages in terms of storage, performance, and accuracy, over conventional vector database technologies.

In some embodiments, the weighting function 120 may be simple, such as the average-based weighting function discussed above. In other embodiments, the weighting function 120 may be complex. For example, in one embodiment, the weighting function 120 may consider the content of what is being weighted using a large language model, and assign a weight 200 to the update vector 210 that is based upon a multi-step analysis performed by the LLM. Those skilled in the art will recognize that other weighting functions 120 may be used that can be tailored to the specific use case.

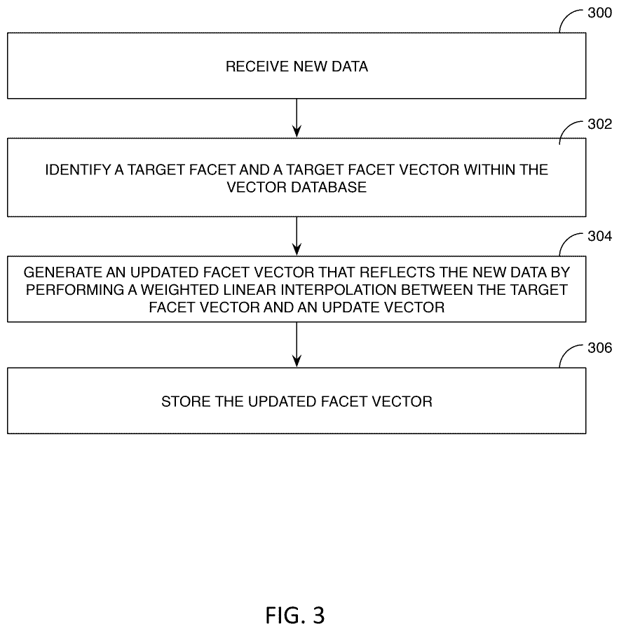

FIG. 3 is a flowchart of a non-limiting example of a method for updating a vector database through continuous vectorization. According to various embodiments, at step 300 new data 206 is received. In some embodiments, the new data 206 may be a vector 114 (i.e., the update vector 210). In other embodiments, the new data 206 may be raw data 208 that will be vectorized with an embedding model 118.

At step 302, a target facet 202 and target facet vector 204 are identified within the vector database 104. The target facet vector 204 belongs to, or is pointed at by, the target facet 202. According to various embodiments, the target facet 202 and target facet vector 204 are identified using at least one of a value 122 of the new data 206 and an attribute 124 of the new data 206.

At step 304, an updated facet vector 212 that reflects the new data 206 is generated by performing a weighted linear interpolation between the target facet vector 204 and an update vector 210.

The update vector 210 is the new data 206 in a vectorized form. According to various embodiments, before performing the linear interpolation the update vector 210 is multiplied by a weight 200 produced by a weighting function 120 and the target facet vector 204 is multiplied by one minus the weight 200.

Finally, at step 306, the updated facet vector 212 is stored within the vector database 104. In some embodiments, the target facet vector 204 is overwritten by the updated facet vector 212 within the vector database 104.

The following is a series of exemplary use cases for the contemplated system and method for continuous vectorization. These use cases are meant for illustrative purposes, demonstrating how CV improves upon the technology of vector databases in a number of significant ways. These examples are not presented as limitations, or examples of the only way CV could be applied to a particular use case, and should not be interpreted as the only way CV could be applied advantageously to a use case.

Additionally, continuous vectorization's ability to reduce a complicated collection of information to a single vector 114 in a facet 116 that is continuously updated is meant to illustrate a simple implementation, and is not meant to preclude the inclusion of additional vectors 114 in a facet 116, as has been discussed above.

As a specific, non-limiting example, continuous vectorization (CV) may be advantageously used in an advanced scientific literature search engine. Research institutions and universities increasingly rely on AI-powered systems to search and analyze the ever-growing body of scientific literature. These systems use vector embeddings to represent and process multidimensional data about research papers, including text, citations, and metadata. However, conventional vector storage systems face significant challenges in this domain. The need to store individual vector embeddings for each research paper and its components results in massive storage demands. Additionally, frequently re-vectorizing entire research corpora to accommodate newly published material is computationally expensive. Keeping search results relevant in real-time as the scientific landscape evolves rapidly is another hurdle. Furthermore, connecting research across various disciplines is a crucial yet difficult task with traditional search methods, as these methods often fail to identify cross-disciplinary connections effectively.

The application of continuous vectorization technology significantly improves the efficiency and effectiveness of scientific literature search engines. By maintaining a single, continuously updated vector 114 per research topic and author profile, CV substantially reduces storage requirements. This reduction allows for the retention of a more comprehensive body of literature without needing to invest in additional infrastructure.

CV eliminates the need for batch updates when new papers are published. Instead, it uses weighted linear interpolation to dynamically update existing vectors 114. This enables search results to immediately reflect the latest research trends and findings, providing users with near-instantaneous access to the most relevant information.

Another major improvement is CV's ability to enhance semantic understanding. Continuous updates allow the system to better represent evolving scientific concepts and relationships. This results in more accurate and nuanced search outcomes, capturing new developments in scientific terminology and theories.

CV also excels at fostering cross-disciplinary discovery. By efficiently updating topic vectors 114, it improves the representation of emerging interdisciplinary connections. This makes it easier to surface research from adjacent fields, potentially leading to breakthrough discoveries at the intersection of disciplines.

In addition to this, CV can continuously update user profile vectors 114 based on researchers' evolving interests, ensuring that paper recommendations are relevant and timely. This personalized approach helps researchers stay up-to-date with minimal effort on their part.

These advancements are powered by several key components of continuous vectorization. A weighting function 120 tailored to balance new publications against established literature ensures that high-impact papers influence topic vector representations appropriately. Facets may be defined by topics, methodologies, and author networks, which enable targeted updates and more precise searches. Linear interpolation allows the smooth integration of new research into existing vectors 114, preserving the continuity of scientific knowledge while incorporating cutting-edge findings. The continuous updating mechanism ensures that vector embeddings reflect the latest state of scientific knowledge, keeping search indices and recommendation systems up to date.

This application of CV could significantly advance scientific discovery and collaboration. It addresses critical challenges in managing and searching large-scale, rapidly evolving scientific literature, making it highly relevant to research institutions and universities, scientific publishers and aggregators, AI companies focusing on knowledge management, as well as pharmaceutical and biotech companies for drug discovery research.

Continuous vectorization enables more efficient, accurate, and timely literature searches, which could accelerate the pace of discovery and encourage greater cross-disciplinary collaboration. By improving the identification of emerging trends and reducing the latency in updating search indices, CV could facilitate faster scientific breakthroughs and more effective knowledge sharing. Its reduced storage and computational requirements also lower operational costs and increase the scalability of AI systems to manage growing volumes of scientific data.

This contemplated CV-powered scientific literature search engine has the potential to become an essential tool for researchers, universities, and other scientific organizations, offering speed, accuracy, and insight in navigating the expanding sea of scientific knowledge.

As another specific, non-limiting example, continuous vectorization may be advantageously used in an e-commerce product discovery platform. E-commerce platforms use AI-powered systems to assist customers in discovering products from their vast and constantly changing inventories. These systems use vector embeddings to represent and process multidimensional data about products, user preferences, and shopping behaviors. However, traditional vector storage systems face significant problems. Storing individual vector embeddings for each product and user interaction quickly results in massive storage requirements. Additionally, re-vectorizing product catalogs to reflect inventory changes and emerging trends is computationally expensive. Another major issue is real-time personalization—user preferences can shift rapidly, requiring frequent updates to search and recommendation models. Lastly, traditional methods often struggle to help users discover long-tail products that match specific needs, particularly niche items.

Continuous vectorization technology addresses these problems by significantly enhancing the efficiency and effectiveness of product discovery on e-commerce platforms. One key advantage of CV is its ability to maintain a single, continuously updated vector 114 per product category and user profile. This approach drastically reduces storage requirements, allowing for more comprehensive product and user data retention without increasing infrastructure costs.

Rather than re-vectorizing entire catalogs when product details or popularity shift, CV uses weighted linear interpolation to dynamically update vectors 114. This method ensures that search results are almost instantly reflective of the latest product trends, availability, and customer preferences, eliminating the need for batch updates. Real-time personalization is another strength of CV, as user profile vectors 114 are continuously updated based on browsing and purchasing behavior. This results in more accurate and timely personalized search results that can adapt quickly to shifting user preferences.

CV also excels at enhancing the discovery of long-tail products. The efficient updating of product vectors 114 allows for a better representation of niche items and their relationships to broader categories. This increases the visibility of lesser-known products in search results, helping users find items that match their specific needs more effectively. Furthermore, CV enables trend-aware search rankings by continuously updating product vectors 114 to capture emerging market trends and seasonal patterns, improving the overall discovery experience and potentially boosting sales.

CV's efficient updating mechanism also supports scalability. As product catalogs and user bases expand, CV's ability to update vectors 114 dynamically without the need for large-scale batch processing allows for continued system growth without a corresponding increase in computational resources. This scalability ensures that even as platforms grow, recommendation quality and response times remain high.

Several core components of CV power these advancements. The weighting function 120 can be tailored to balance recent user interactions with long-term preferences, such as giving higher weight 200 to recent purchases to reflect current interests while maintaining stability in overall preferences. Facets may be defined based on product categories, attributes, and user interaction patterns, allowing for targeted updates and refined searches. Linear interpolation ensures smooth integration of new product information and user interactions into existing vectors 114, preserving the continuity of product relationships and user preferences while incorporating new data. The continuous updating mechanism keeps vector embeddings up to date with the latest state of the product catalog and user behavior, which is critical for maintaining relevant search indices and recommendation systems.

The impact of CV on the e-commerce industry could be significant. It enables more efficient, accurate, and personalized product search, which could improve customer satisfaction, increase conversion rates, and drive revenue growth. CV's ability to handle vast amounts of product and user data more efficiently could lead to more engaging shopping experiences and better inventory management. By reducing operational costs through lower compute and storage requirements and increasing scalability to manage growing product catalogs and user bases, CV could offer businesses of all sizes a competitive edge in the e-commerce space.

This contemplated CV-powered e-commerce product discovery platform could become an essential tool for online retailers, offering a highly personalized and efficient shopping experience that rivals or exceeds the performance of e-commerce giants.

As yet another specific, non-limiting example, continuous vectorization may be advantageously used in a legal document search and analysis system. Law firms and legal departments manage vast repositories of legal documents, such as case law, contracts, and regulations, and are beginning to turn to AI-powered systems for efficient search and analysis. These systems rely on vector embeddings to process the multidimensional data within legal texts and their relationships. However, traditional vector storage systems present significant challenges. Storing individual vector embeddings for each legal document and its components leads to massive storage demands. Furthermore, re-vectorizing entire corpora to incorporate new laws, rulings, or interpretations is computationally expensive. Legal searches also require nuanced contextual understanding, which is difficult to achieve with conventional keyword-based systems. Finally, identifying relevant legal documents across different jurisdictions is a crucial yet complex task.

Continuous vectorization technology offers substantial improvements for legal document search and analysis. One of CV's major advantages is its ability to maintain a single, continuously updated vector 114 per legal topic, jurisdiction, and document type. This approach dramatically reduces storage requirements, allowing legal systems to cover a more comprehensive range of legal documents without needing additional infrastructure.

CV reduces the need for computationally expensive batch updates by using weighted linear interpolation to dynamically update existing vectors 114 as new rulings or laws emerge. This allows search results to reflect the latest legal developments in near real-time, ensuring that legal professionals always have access to the most current and relevant information. Additionally, CV's continuous updating mechanism enhances the system's contextual understanding of legal concepts. This improvement results in more accurate search outcomes, capturing nuanced interpretations and applications of legal principles.

Another strength of CV is its ability to provide cross-jurisdictional insight. The efficient updating of jurisdiction-specific vectors 114 allows the system to better represent legal similarities and differences across regions. This makes it easier to surface relevant cases or regulations from different jurisdictions, supporting more comprehensive legal research. Additionally, CV can continuously track the evolving significance of legal precedents, helping legal professionals identify relevant precedents, including recent rulings that might affect case outcomes.

Several key components of CV enable these advancements. A tailored weighting function 120 can balance the importance of new rulings against established precedents, ensuring that landmark cases significantly influence legal concept vector representations. Legal facets 116 may be defined based on areas of law, jurisdictions, and document types, enabling more targeted searches and updates. Linear interpolation allows for the seamless integration of new legal developments into existing vector embeddings, preserving the continuity of legal knowledge while incorporating the latest rulings and interpretations. The continuous updating mechanism ensures that vector embeddings remain up to date with the current legal landscape.

CV could have a profound impact on the legal industry by enabling more efficient, accurate, and context-aware legal document search and analysis. It could improve the quality of legal research, enhance decision-making in cases, and ultimately contribute to more effective legal practice. CV's ability to handle vast amounts of legal data more efficiently could also lead to the discovery of non-obvious legal connections and trends, potentially uncovering novel legal strategies or areas for policy reform.

This contemplated CV-powered legal document search and analysis system could become an indispensable tool for legal professionals, offering unparalleled speed, accuracy, and insight in navigating the complex and ever-changing legal landscape.

As another specific, non-limiting example, the contemplated continuous vectorization system may be used to enhance multimedia content searching for streaming platforms. Streaming platforms use AI-powered systems to help users discover relevant content from vast libraries of media such as videos, music, and podcasts. These systems rely on vector embeddings to represent and process multidimensional data about content, user preferences, and viewing/listening behaviors.

Approaching this task with conventional vector database technology presents a number of problems. Storing individual vector embeddings for each piece of content and user interaction leads to massive storage requirements. Additionally, this will be computationally intensive, as frequent re-vectorization of content libraries to reflect new additions and changing popularity is computationally taxing. Also, effectively searching across different types of media (e.g., video, audio, text) is complex and often inaccurate. Providing personalized content recommendations for millions of users with diverse and changing tastes is challenging and will require significant storage and computing resources.

The continuous vectorization system and method contemplated herein addresses these challenges. Because continuous vectorization would be able to maintain a single, continuously updated vector 114 per content category and user profile, the storage requirements would be substantially reduced. This would also allow for more comprehensive content and user data retention without increased infrastructure costs.

Using continuous vectorization, re-vectorizing the entire library as content popularity or metadata changes is no longer necessary. Instead, weighted linear interpolation is used to update existing vectors 114 to reflect the changes. This means search results will reflect the latest content trends and additions almost instantaneously, without the need for batch updates.

Furthermore, CV's efficient updating mechanism allows for better representation of the relationships between different media types. This means the user can receive more accurate cross-media search results, enabling them to find relevant content regardless of media type.

Continuous vectorization makes incorporating new or updated information faster and more efficient. This means that user profile vectors 114 can be continuously updated based on viewing/listening behavior, resulting in more accurate and timely personalized search results that adapt quickly to changing user preferences across different media types.

Finally, since continuously updating is not an expensive endeavor with CV, having continuously updated content vectors 114 will capture emerging trends and seasonal patterns in viewing/listening habits. This makes it easier to provide search rankings that adapt dynamically to popular trends, improving content discovery and potentially increasing user engagement.

Continuous vectorization is able to provide these advantages through considered application of the weighting function 120 and definition of facets 116. The weighting function 120 can be tailored to balance the importance of recent user interactions against long-term preferences (e.g., recent views may be given higher weight 200 to capture current interests while maintaining overall taste profile stability, etc.). The facets 116 may be defined based what information is of greatest use (e.g., genres, themes, creators, user interaction patterns, etc.). User facets 116 may be defined based on aspects of user behavior that have greatest impact on their interactions/searches (e.g., viewing/listening history, preferences, demographic information, etc.). Defining facets 116 such as these enable targeted updates and searches across specific aspects of the content library and user base.

The linear interpolation at the core of continuous vectorization allows smooth integration of new content information and user interactions into existing vector embeddings. This preserves the continuity of content relationships and user preferences while still incorporating new data. This easy updating ensures vector embeddings always reflect the latest state of the content library and user behaviors. This can be critical for maintaining up-to-date search indices and recommendation systems in a dynamic streaming environment.

Continuous vectorization could significantly advance multimedia content discovery and personalization. It addresses critical challenges in managing and searching large-scale, diverse content libraries, making it highly relevant to streaming platforms (e.g., video, music, podcast, etc.), content production companies, AI companies focusing on recommendation systems, advertising networks targeting streaming audiences, and similar industries.

By enabling more efficient, accurate, and personalized content search, CV has the potential to improve user satisfaction, increase engagement time, and ultimately drive subscriber growth and retention. The system's ability to handle vast amounts of multi-modal content and user data more efficiently could lead to more engaging entertainment experiences and better content curation.

Not only can continuous vectorization do the job of a conventional vector database at lower storage/computational expense, but it can also do the job better. CV allows more relevant and personalized content search results across media types, faster adaptation to changing user preferences and content trends, and improved discovery of niche content that matches specific user interests. Other advantages include reduced latency in updating search indices with new content or popularity changes, lower operational costs due to reduced compute and storage requirements, and increased scalability to handle growing content libraries and user bases. And since CV can be implemented at any scale, these benefits would be available to streaming platforms of all sizes.

As a specific, non-limiting example, continuous vectorization may be advantageously used in an enterprise knowledge management system. Large corporations increasingly rely on AI-powered systems to manage and search through their vast repositories of internal documents, including reports, emails, presentations, and project documentation. These systems use vector embeddings to represent and process the multidimensional data about documents, their relationships, and user access patterns. However, conventional vector storage systems face significant problems. Storing individual vector embeddings for each document and its components leads to massive storage requirements, particularly for enterprises managing millions of documents. Frequent re-vectorization of the entire corpus to incorporate new documents and updates is computationally expensive. Additionally, cross-departmental relevance is often difficult to establish with traditional search methods, leaving valuable information siloed in specific departments. The dynamic and frequently changing access patterns of employees also necessitate constant updates to search relevance models.

Continuous vectorization offers a transformative solution for enterprise knowledge management systems, according to various embodiments. One of the core advantages of CV is its ability to maintain a single, continuously updated vector 114 per document type, project, and department. This dramatically reduces storage requirements, allowing organizations to cover a broader range of documents without increasing infrastructure costs.

CV also eliminates the need for batch re-vectorization when new documents are added or modified. Instead, it uses weighted linear interpolation to update existing vectors 114 in real-time. This ensures that search results reflect the most current organizational knowledge almost instantaneously, improving the efficiency and effectiveness of enterprise search functions.

In addition, CV enhances cross-departmental discovery by continuously updating relationships between documents across different organizational silos. This facilitates more accurate and relevant search results that surface valuable information from disparate parts of the organization. The system's ability to break down information silos fosters greater collaboration and innovation by enabling the discovery of connections between seemingly unrelated documents.

Furthermore, CV adapts quickly to the dynamic access patterns of employees. By continuously updating user interaction vectors 114 based on search and access behaviors, it provides more accurate and personalized search results that evolve in response to changing organizational needs and priorities.

Several key components of CV enable these advancements. The weighting function 120 can be tailored to balance document recency, user access patterns, and organizational hierarchy, ensuring that recent and frequently accessed documents are given higher weight 200 in search results while maintaining foundational knowledge. Facets can be defined based on document type, department, project, and user roles, enabling targeted updates and searches across the organization. Linear interpolation allows for the smooth integration of new document information and user interactions into existing vector embeddings, preserving continuity while incorporating new data. The continuous updating mechanism ensures that vector embeddings always reflect the latest state of organizational knowledge and user behavior, which is crucial for maintaining up-to-date search indices in a constantly evolving corporate environment.

The application of CV in enterprise knowledge management could have a profound impact on productivity and decision-making within large organizations. By enabling faster and more accurate discovery of relevant information across departmental boundaries, CV helps surface expertise and knowledge that may otherwise remain hidden. The system's efficiency in handling vast amounts of corporate data reduces operational costs, while its scalability ensures that growing volumes of documents and users can be managed effectively. Moreover, the ability to break down information silos and foster collaboration across departments could lead to significant innovation and competitive advantage.

This contemplated CV-powered enterprise knowledge management system could become an indispensable tool for large corporations across all sectors, offering unparalleled speed, accuracy, and insight in navigating complex internal knowledge landscapes.

As still another specific, non-limiting example, continuous vectorization may be advantageously used in a real-time news analysis and recommendation system. News aggregators and media companies face the challenging task of analyzing, categorizing, and recommending news articles in real-time. These systems rely on vector embeddings to represent and process the multidimensional data of news content, including text, metadata, and user interactions. However, conventional vector storage systems face critical limitations. Storing individual vector embeddings for each news article and user interaction results in massive storage demands. Re-vectorizing news datasets to incorporate breaking stories and evolving narratives is computationally expensive, while maintaining real-time analysis and content relevance in a rapidly changing news cycle is another substantial hurdle.

Continuous vectorization significantly improves the efficiency and performance of news analysis and recommendation systems. One of CV's primary advantages is its ability to maintain a single, continuously updated vector 114 per news topic and user interest profile, dramatically reducing storage requirements. This reduction allows for the retention of more comprehensive news content and user data without requiring additional infrastructure.

By using weighted linear interpolation, CV updates vectors 114 in real-time as new articles are published and user interactions occur. This eliminates the need for costly batch updates and enables near-instantaneous analysis of news trends and user interests. As a result, vector embeddings continuously reflect the most current information, allowing news categorization and recommendation systems to respond quickly to breaking news and shifting narratives.

In addition to improved real-time analysis, CV enhances the representation of evolving news topics and user interests. Its efficient updating mechanism allows for more nuanced content categorization and a better understanding of changing news landscapes, resulting in more accurate recommendations. Furthermore, CV-powered systems are able to continuously update user profile vectors 114 based on reading habits and interactions, ensuring that recommendations are relevant to users'evolving interests.

Several CV components drive these improvements. The weighting function 120 can be tailored to prioritize breaking news over established narratives, ensuring that high-impact events significantly influence topic vector representations. Facets can be defined based on categories such as topics, geographic regions, and news sources, enabling targeted updates and searches within the news ecosystem. Linear interpolation allows for the smooth integration of new articles and user interactions into existing vectors 114, preserving the continuity of news narratives while incorporating new data. The continuous updating mechanism ensures that vector embeddings reflect the latest news content and user behavior, which is essential for maintaining up-to-date topic models and recommendation systems.

The impact of CV on the news and media industry could be substantial. By enabling more efficient, accurate, and timely analysis of news content, CV improves the ability to detect breaking news, categorize content, and provide personalized recommendations. This can lead to a more engaged and informed readership, with news platforms benefiting from increased user satisfaction and retention. Moreover, CV's ability to handle large-scale, continuously changing data streams reduces operational costs and increases scalability, allowing news platforms to manage growing volumes of content and users more effectively.

This contemplated CV-powered real-time news analysis and recommendation system could become an essential tool for media companies seeking to stay competitive in the fast-paced digital news landscape, offering unmatched speed, accuracy, and efficiency in news analysis and recommendation.

As a specific, non-limiting example, continuous vectorization may be advantageously used in an environmental monitoring and climate change analysis system. Environmental agencies and research institutions use AI-powered systems to analyze large quantities of climate data to monitor and predict climate change patterns. These systems rely on vector embeddings to manage multidimensional data streams from a wide array of sources, such as sensors, satellite data, and historical climate records. Traditional vector storage systems, however, present several limitations in this domain. The need to store individual vector embeddings for each data point leads to exponential growth in storage demands. Additionally, frequent re-vectorization of datasets to incorporate new information is computationally expensive. Moreover, real-time analysis is crucial in this field, as climate patterns change rapidly. The high computational demands of constant re-vectorization also result in significant energy consumption, which poses a challenge, particularly for systems trying to align with sustainability goals.

Continuous vectorization technology offers a transformative solution for environmental monitoring and climate change analysis systems. CV's ability to maintain a single, continuously updated vector 114 per climate facet 116—such as geographical regions or climate variables—significantly reduces storage requirements. This allows organizations to retain more comprehensive historical and real-time climate data without the need for additional infrastructure.

Rather than re-vectorizing entire datasets, CV uses weighted linear interpolation to update existing vectors 114 as new climate data becomes available. This reduces the computational load and enables more frequent updates to the models, allowing for near real-time analysis of climate trends. The ability of CV to incorporate new data almost instantaneously ensures that environmental monitoring systems can respond quickly to emerging patterns or extreme weather events, which is critical for effective climate change mitigation and disaster preparedness.

In addition to enhancing real-time analysis, CV's efficient updating mechanism allows for better representation of complex climate interactions and long-term trends. This results in more accurate climate models that can capture intricate relationships between various climate variables. Another major advantage of CV is its energy efficiency—by reducing the computational demands of vector processing, CV translates into lower energy consumption, which is aligned with the sustainability goals of environmental agencies and institutions.

Key components of CV enable these improvements. The weighting function 120 can be tailored to prioritize new and extreme climate events over established data, ensuring that significant weather occurrences influence climate vector representations. Facets may be defined based on relevant categories such as geographical regions and climate variables, allowing for targeted analysis of specific aspects of the climate system. Linear interpolation ensures the smooth integration of new data into existing vector embeddings, preserving the continuity of climate trends while incorporating new information. CV's continuous updating mechanism keeps vector embeddings up to date with the latest climate data, which is essential for monitoring rapid environmental changes and providing accurate inputs for AI models.

The application of CV in environmental monitoring and climate change analysis could have a profound impact on the field. By enabling more efficient, accurate, and sustainable climate data analysis, CV improves early warning systems for extreme weather events, enhances long-term climate projections, and contributes to more effective climate change mitigation strategies. The system's ability to handle vast amounts of climate data more efficiently could lead to breakthroughs in understanding complex climate systems and their interactions, potentially uncovering new patterns or correlations that were previously undetectable.

This contemplated CV-powered environmental monitoring system could become an essential tool for government agencies, research institutions, and tech companies developing AI solutions for climate analysis, offering unparalleled speed, accuracy, and sustainability in managing and interpreting climate data.

As a specific, non-limiting example, continuous vectorization may be advantageously used in a large-scale genetic analysis system for disease research. Research institutions and biotech companies increasingly rely on AI-powered systems to analyze vast amounts of genomic data for disease research and drug discovery. These systems use vector embeddings to represent and process multidimensional genetic data from millions of individuals and organisms. However, traditional vector storage systems face significant challenges in this domain. Storing individual vector embeddings for each genetic sequence leads to enormous storage demands. Additionally, frequent re-vectorization of genomic datasets to incorporate new discoveries is computationally expensive. Real-time analysis is critical in this field, as new genetic associations are constantly being discovered. Furthermore, the complexity and interconnectedness of genetic data make it difficult to represent and analyze efficiently.

Continuous vectorization technology provides a powerful solution to these challenges in genetic analysis and disease research. CV's ability to maintain a single, continuously updated vector 114 per genetic facet 116—such as gene function or disease association—significantly reduces storage requirements. This reduction allows for the retention of more comprehensive genetic datasets without increasing infrastructure costs, making it easier to handle the massive volume of data generated in genomic research.

Instead of re-vectorizing entire genomic datasets when new genetic discoveries are made, CV uses weighted linear interpolation to update existing vectors 114. This reduces the computational cost of updates, enabling more frequent model adjustments and faster incorporation of new genetic information. CV's real-time vector updates allow near-instantaneous analysis of genetic trends, ensuring that genetic models are always reflective of the most current discoveries. This capability is crucial for research in disease mechanisms, where new gene-disease associations must be quickly integrated into ongoing analyses.

CV also excels at handling the complexity of genetic data. Its efficient updating mechanism allows for better representation of complex genetic interactions and pathways, leading to more accurate models and potentially novel insights. The continuous integration of new genetic data preserves the continuity of genetic knowledge while still incorporating cutting-edge findings, enhancing the predictive power of AI-driven analyses.

Several key components of CV drive these advancements. The weighting function 120 balances the influence of new genetic discoveries with established knowledge, ensuring that newly identified gene-disease associations significantly impact the overall vector representations. Facets may be defined based on relevant categories such as gene functions, metabolic pathways, and disease associations, enabling targeted updates and more precise analysis of specific aspects of the genetic landscape. Linear interpolation allows for the smooth integration of new data into existing vectors 114, ensuring that the continuity of genetic knowledge is maintained. CV's continuous updating mechanism ensures that vector embeddings reflect the latest genetic research, which is essential for maintaining accurate and up-to-date models in disease research.

The impact of CV on genomic research and drug discovery could be transformative. By enabling more efficient, accurate, and comprehensive analysis of genetic data, CV enhances the understanding of disease mechanisms, accelerates drug discovery, and optimizes personalized treatment approaches. The system's ability to handle vast amounts of complex genetic data more efficiently could lead to breakthroughs in understanding intricate genetic interactions and their role in diseases, potentially uncovering novel therapeutic targets and treatment strategies.

This contemplated CV-powered genetic analysis system could become an indispensable tool for research institutions, biotech companies, and healthcare providers, offering unparalleled speed, accuracy, and insight in managing and interpreting large-scale genetic data.

As a specific, non-limiting example, continuous vectorization may be advantageously used in a smart city infrastructure management system. Smart cities leverage AI-powered systems to manage and optimize urban infrastructure, including traffic flow, energy usage, and public transportation. These systems rely on vector embeddings to represent and process data streams from millions of IoT devices and sensors scattered throughout the city. However, traditional vector storage approaches present significant challenges. Storing individual vector embeddings for each data point from these numerous sensors results in massive storage demands. Additionally, frequent re-vectorization of city-wide data to incorporate new information is computationally expensive. Real-time analysis is critical in smart city management, as urban conditions such as traffic congestion, energy consumption, and public transportation needs can change rapidly. Furthermore, the computational demands of constant re-vectorization result in high energy consumption, which is at odds with the sustainability goals of smart cities.

Continuous vectorization technology offers a transformative solution for smart city infrastructure management. One of CV's key advantages is its ability to maintain a single, continuously updated vector 114 per urban infrastructure facet 116, such as traffic patterns or energy grids. This approach dramatically reduces storage requirements, allowing for the retention of comprehensive historical and real-time urban data without increasing infrastructure costs.

Rather than re-vectorizing entire datasets when new data arrives from city-wide sensors, CV uses weighted linear interpolation to update existing vectors 114. This approach significantly reduces the computational load, enabling more frequent updates to the models and allowing for real-time analysis of urban trends. By continuously incorporating new data almost instantaneously, CV ensures that urban management systems can respond quickly to changing conditions, whether it be a traffic incident or a spike in energy demand.

CV also contributes to smart cities'sustainability goals by reducing energy consumption. The reduced computational load translates directly into lower energy usage, which is critical for minimizing the environmental footprint of smart city operations.

Several key components of CV power these advancements. The weighting function 120 can prioritize new urban data over historical trends, ensuring that recent incidents such as traffic jams or power outages significantly influence vector representations. Facets may be defined based on relevant urban categories, such as traffic zones, energy grids, and public transportation routes, enabling targeted analysis and more accurate system responses. Linear interpolation allows for the smooth integration of new data into existing vector embeddings, preserving continuity in urban patterns while incorporating new information. CV's continuous updating mechanism ensures that vector embeddings reflect the latest city data, which is critical for monitoring rapid urban changes and providing up-to-date inputs to AI-driven city management models.

The application of CV in smart city infrastructure management could have a significant impact on urban planning and operations. By enabling more efficient, accurate, and sustainable data analysis, CV improves traffic management, optimizes energy distribution, and enhances public transportation efficiency. The system's ability to handle vast amounts of urban data more efficiently could also lead to breakthroughs in understanding complex urban dynamics, potentially uncovering new approaches to long-standing challenges in urban planning.

This contemplated CV-powered smart city management system could become an indispensable tool for city governments, urban planners, and IoT companies, offering unparalleled speed, accuracy, and sustainability in managing the vast and complex data streams generated by smart city infrastructure.

As a specific, non-limiting example, continuous vectorization may be advantageously used in a personalized medicine and treatment optimization system. Healthcare providers and research institutions increasingly rely on AI-powered systems to analyze patient data to develop personalized treatment plans and predict drug efficacy. These systems use vector embeddings to represent and process multidimensional data related to patients, including genomic information, medical histories, and real-time health metrics. Traditional vector storage systems face significant problems in this domain. Storing individual vector embeddings for each patient data point leads to massive storage requirements. Additionally, frequent re-vectorization of patient histories to accommodate new health data is computationally expensive. Real-time analysis is critical, as patient conditions can change rapidly, requiring timely adjustments to treatment plans. The storage and processing of numerous vectors 114 also increase the risk of data breaches, raising concerns about patient data privacy.

Continuous vectorization technology offers a powerful solution for personalized medicine and treatment optimization. CV's ability to maintain a single, continuously updated vector 114 per patient profile significantly reduces storage requirements. This approach allows healthcare providers to retain comprehensive patient histories without the need for additional infrastructure, thereby facilitating long-term tracking and analysis of patient data.

Rather than re-vectorizing entire patient histories when new data arrives, CV uses weighted linear interpolation to update existing vectors 114 dynamically. This reduces the computational burden of updates and enables more frequent model adjustments, allowing for real-time analysis of patient health trends. As new data streams in from wearable devices, health monitoring systems, and check-ups, CV-powered systems can immediately update patient profiles, ensuring that treatment recommendations remain current and accurate.

CV also contributes to enhanced data privacy. By reducing the number of stored vectors 114, CV lowers the attack surface for potential data breaches, improving data security and making it easier for healthcare providers to comply with privacy regulations such as HIPAA.

Key components of CV drive these advancements. The weighting function 120 can be tailored to prioritize acute health events over long-term trends, ensuring that recent and significant changes in a patient's condition significantly influence their treatment plan. Facets may be defined based on relevant categories such as medical conditions, treatment plans, and demographic data, allowing for targeted analysis of specific aspects of patient health. Linear interpolation ensures the smooth integration of new health data into existing vector embeddings, preserving the continuity of patient health trends while incorporating new information. CV's continuous updating mechanism ensures that patient profiles are up to date, which is critical for monitoring rapid changes in health and providing accurate inputs for AI-driven treatment models.

The impact of CV on personalized medicine could be substantial. By enabling more efficient, accurate, and secure patient data analysis, CV enhances the ability of healthcare providers to deliver personalized treatments that are better aligned with individual patient needs. This could improve treatment outcomes, accelerate drug discovery processes, and ultimately contribute to more effective and tailored healthcare delivery. The system's ability to handle vast amounts of patient data more efficiently could also lead to breakthroughs in understanding complex disease mechanisms, potentially uncovering novel therapeutic approaches and enabling more precise interventions.

This contemplated CV-powered personalized medicine and treatment optimization system could become an essential tool for healthcare providers, pharmaceutical companies, and research institutions, offering unmatched speed, accuracy, and security in managing patient data and optimizing treatment strategies.

The following is a discussion comparing the performance of the contemplated continuous vectorization system 100 with a conventional vectorization approach on a specific, non-limiting example of a use case for vector databases. The data set to be vectorized by the two approaches is made up of roughly 50,000 books in the public domain, obtained from Project Gutenberg. The data set is roughly 17 gigabytes of raw text data.

Two vector databases are formed, one using standard vectorization and the other using continuous vectorization. The weighted interpolation of continuous vectorization preserves relevance while reducing storage requirements. The storage advantages of the contemplated CV method are significant: the standard vectorization method requires roughly 1.5 terabytes, while the continuous vectorization method actually shrinks the storage requirements to roughly 0.5 gigabytes. In this specific, non-limiting example involving the vectorization of literature, the contemplated continuous vectorization method reduced the storage requirements of the vectorized data by a factor of 300× compared to conventional vectorization.

As previously discussed, the contemplated system and method is able to provide storage advantages without sacrificing performance or accuracy. Continuous vectorization essentially transforms facets from passive organizational units into active semantic “maintainers” that ensure the semantic meaning is preserved across continuous updates. This can be seen in a comparison between the accuracy of the standard and continuous vector data sets of the specific non-limiting example discussed above.

Both vector databases were given the query “Find authors whose writing style is most similar to Shakespeare”. The top 10 results were returned from each database, ranked by an L2 distance. The L2 distance represents the distance between the query and the book being searched for represented as a number from 0 to 1. The smaller the number is, the more relevant to the query the content in the book is.

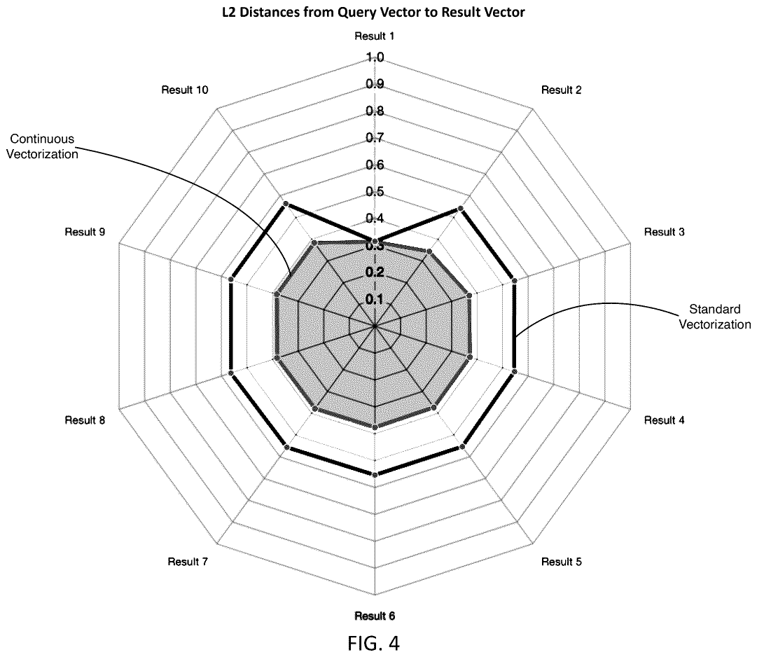

FIG. 4 shows a relevance plot of the L2 distances from query vectors to result vectors for the top ten results obtained through the specific non-limiting examples of standard and continuous vector databases. As suggested by the plot, both databases returned the same top result, “Shakespeare's First Folio”. However, for the remaining nine books the continuous vectorization database returned results with better (i.e., shorter) L2 distances than the standard vector database. Not only does CV offer substantial storage savings, but it can also provide more accurate results in a semantic search.

It should be noted that this preservation of semantic meaning while also reducing storage requirements is an emergent capability that cannot be achieved through faceting or weighting alone. The interaction between these components enables dynamic semantic maintenance without the storage overhead typically associated with vector databases. In conventional systems, an improvement in one of these aspects comes at the expense of the other.

It will be understood that implementations are not limited to the specific components disclosed herein, as virtually any components consistent with the intended operation of a system and method for updating a vector database through continuous vectorization may be utilized. Accordingly, for example, although particular systems, methods, and/or devices for vectorization, storage, and retrieval of vectors and facets may be disclosed, such components may comprise any shape, size, style, type, model, version, class, grade, measurement, concentration, material, weight, quantity, and/or the like consistent with the intended operation of a system and method for updating a vector database through continuous vectorization may be used. In places where the description above refers to particular implementations of a system and method for updating a vector database through continuous vectorization, it should be readily apparent that a number of modifications may be made without departing from the spirit thereof and that these implementations may be applied to other vector storage systems and systems for embedding data streams.

What is claimed is:

1. A method for updating a vector database, comprising:
receiving a new data;
identifying within the vector database a target facet and a target facet vector, using at least one of a value of the new data and an attribute of the new data, the target facet vector belonging to the target facet;
generating an updated facet vector that reflects the new data by performing a weighted linear interpolation between the target facet vector and an update vector, the update vector being the new data in a vectorized form, with the update vector being multiplied by a weight w produced by a weighting function and the target facet vector being multiplied by (1−w); and
storing the updated facet vector within the vector database.

2. The method of claim 1, further comprising generating the update vector by vectorizing the new data with an embedding model, wherein the new data is received as raw data.

3. The method of claim 1, wherein the target facet comprises at most one vector.

4. The method of claim 1, wherein storing the updated facet vector within the vector database comprises overwriting the target facet vector with the updated facet vector.

5. The method of claim 1, further comprising storing the update vector within the vector database.

6. The method of claim 1, wherein the weighting function depends, at least in part, on a vector count, the vector count being the number of vectors that have been combined through linear interpolation to yield the target facet vector.

7. The method of claim 6:
wherein the weighting function is average-based, and
wherein, if n is the vector count, the weight is 1/(n+1).

8. The method of claim 1:
wherein the weighting function is order-based, and
wherein the weight is equal to a decay factor that is greater than 0 and less than 1.

9. The method of claim 8, wherein the decay factor is a function and is dependent on an elapsed time since the target facet vector was last updated.

10. A continuous vectorization system, comprising:
a vector database comprising a plurality of vectors and a plurality of facets, each facet describing at least one vector associated with the facet on the basis of at least one of a value and an attribute reflected by the vector; and
a continuous vectorization server communicatively coupled to the vector database, the continuous vectorization server comprising a processor and a memory, the memory comprising a weighting function and the processor configured to:
receive a new data;
identify a target facet within the vector database using at least one of a value of the new data and an attribute of the new data;
identify a target facet vector belonging to the target facet using the new data;
retrieve the target facet vector from the vector database;
generate a weight w by applying the weighting function to at least a part of at least one of the target facet, the target facet vector, the new data in a raw data form, and the new data in a vectorized form;
create an updated facet vector via a weighted linear interpolation between the target facet vector and an update vector by performing a linear interpolation between the update vector multiplied by the weight and the target facet vector multiplied by (1−w); and
send the updated facet vector to the vector database for storage;
wherein the update vector is the new data in a vectorized form.

11. The continuous vectorization system of claim 10, wherein the processor of the continuous vectorization server is further configured to receive the new data from a client device communicatively coupled to the continuous vectorization server through a network.

12. The continuous vectorization system of claim 10, wherein the vector database is remote and is communicatively coupled to the continuous vectorization server through a network.

13. The continuous vectorization system of claim 10:
wherein the new data is raw data, and
wherein the processor of the continuous vectorization server is further configured to generate the update vector by vectorizing the new data with an embedding model.

14. The continuous vectorization system of claim 10, wherein the target facet comprises, at most, one vector.

15. The continuous vectorization system of claim 10, wherein sending the updated facet vector to the vector database for storage comprises instructing the vector database to overwrite the target facet vector with the updated facet vector.

16. The continuous vectorization system of claim 10, wherein the processor is further configured to send the update vector to the vector database for storage.

17. The continuous vectorization system of claim 10, wherein the weighting function depends, at least in part, on a vector count, the vector count being the number of vectors that have been combined through linear interpolation to yield the target facet vector.

18. The continuous vectorization system of claim 17:
wherein the weighting function is average-based, such that the update vector is weighted the same as any of the n vectors previously interpolated to yield the target facet vector, and wherein, if n is the vector count, the weight is 1/(n+1).

19. The continuous vectorization system of claim 10:
wherein the weighting function is order-based, and
wherein the weight is equal to a decay factor that is greater than 0 and less than 1.

20. The continuous vectorization system of claim 19, wherein the decay factor is a function and is dependent on an elapsed time since the target facet vector was last updated.
